(19) United States
(12) Patent Application Publication
(10) Pub. No.: US 2003/0072837 A1
(43) Pub. Date: Apr. 17, 2003

(54) Apparatus for the manufacture of corrugated plastic pipes

(76) Inventor: Ralph Peter Hegler, (US)

Correspondence Address: Robert F. I. Conte, LEE, MANN, SMITH, McWILLIAMS,, SWEENEY & OHLSON, P.O. Box 2786, Chicago, IL, 60690-2786, US

(21) Appl. No.: 10/266,871

(22) Filed: Oct. 8, 2002

(30) Foreign Application Priority Data
Oct. 16, 2001 (DE) 101 52 638.5

(51) Int. Cl. B29C 47/00

(52) U.S. Cl. 425/382.3

(57) ABSTRACT

An apparatus for the manufacture of corrugated plastic pipes, in particular tubes, comprises a mold chain which is formed of half shells and which is drivable to circulate on a machine bed. The half shells combine on the molding path to form a closed mold. They are passed along feed rollers and return rollers. The return rollers are adjustable in the direction of production.

### BACKGROUND OF THE INVENTION

1. Field of the Invention

The invention relates to an apparatus for the manufacture of corrugated plastic pipes, comprising a machine bed; a molding path, which extends on the machine bed in a direction of production; two feed and deflection devices upstream of the molding path in the direction of production; two return and deflection devices downstream of the molding path in the direction of production; half shells, which are releasably connected to one another, continuously forming two mold chains, which combine by twos on the molding path, forming a mold, and which are passed along a feed and deflection device and a return and deflection device; and a drive for advancing the half shells through the molding path.

2. Background Art

A great number of apparatuses of the generic type are known for instance from U.S. Pat. No. 4,492,551. These apparatuses serve to manufacture plastic pipes with encircling grooves, so-called corrugated pipes, which may also be flexible corrugated tubes. At their ends, these tubes may have connecting pieces in the form of sockets or spigots or simply smooth connecting pieces that have no grooves and are not corrugated.

For the manufacture of these partially corrugated pipes or tubes of varying diameter or having varying connecting pieces, U.S. Pat. No. 4,325,685 has disclosed to use half shells with differently shaped mold recesses which are arranged on carriages for transverse displacement; the carriages themselves are interconnected forming two chains. This design is extraordinarily complicated. Setting varying lengths of pipes is not possible.

DE 199 14 974 A1 teaches a similar design in which half shells may be exchanged upon return pass of the half shells. Modifying the pipe lengths is not possible.

DE 39 30 318 C1 describes an apparatus of modular design for the manufacture of corrugated plastic pipes, it being possible to obtain varying lengths of the circulating chain, depending on the length of a module.

U.S. Pat. No. 5,693,347 describes half shells, which are not interconnected to form a chain, to be conveyed in the direction of production, adjoining each other by twos on a molding path; the half shells are returned one by one by corresponding conveying means from the downstream end to the upstream end and again led into the molding path. A pair of half shells, for instance for molding a socket, may be in a parking position and can be inserted in the molding path when needed. Apparatuses of this type are suitable primarily for the manufacture of pipes of rather great diameters and cannot be employed in the manufacture of pipes of smaller diameters and corresponding tubes.

### SUMMARY OF THE INVENTION

It is an object of the invention to embody an apparatus of the generic type such that few modifications are required for the manufacture, without waste, of pipes of various lengths, in particular flexible pipes i.e., partially corrugated tubes.

According to the invention, this object is attained by the features wherein the return and deflection devices are mounted on the machine bed for adjustment in the direction of production.

The measures according to the invention enable the length of the mold chains to be modified only by exchange of one or several pairs of half shells so that the entire circulating length of a respective pair of chains corresponds to a whole multiple of the pipe that is to be produced, which ensures manufacture without waste. The return rollers are regulated such that the chains are tightened and may circulate unimpeded.

The infinitely variable adjustment of the return rollers is an especially preferred design, allowing continuous adaptation of the circulating length of the molding chains. It is in particular possible to use half shells of varying length in the direction of production. This permits fine-tuning to varying lengths of the pipes or tubes to be produced.

Further features, details and advantages of the invention will become apparent from the ensuing description of an exemplary embodiment, taken in conjunction with the drawing.

### BRIEF DESCRIPTION OF THE DRAWING

FIG. 1 is a plan view of an apparatus for the manufacture of plastic pipes;

FIG. 2 is a partial cross-sectional view through the apparatus according to FIG. 1;

FIG. 3 is a diagrammatic illustration of a plan view of an apparatus for the manufacture of plastic pipes which has return rollers that are displaceable in the direction of production;

FIG. 4 is a vertical cross section through FIG. 3 on the line IV-IV of FIG. 3;

FIG. 5 is an illustration of a pipe with smooth connecting pieces;

FIG. 6 is a lateral longitudinal view of a mold chain for the manufacture of a pipe according to FIG. 5;

FIG. 7 is a lateral longitudinal view of the mold chain with a reduced number of half shells as compared to FIG. 6;

FIG. 8 is a lateral longitudinal view of a mold chain for the manufacture of a pipe;

FIG. 9 is a lateral longitudinal view of a mold chain with a half shell of reduced length as compared to FIG. 8; and

FIG. 10 is a lateral longitudinal view of a mold chain with two half shells of reduced length as compared to FIG. 8.

### DESCRIPTION OF THE PREFERRED EMBODIMENT

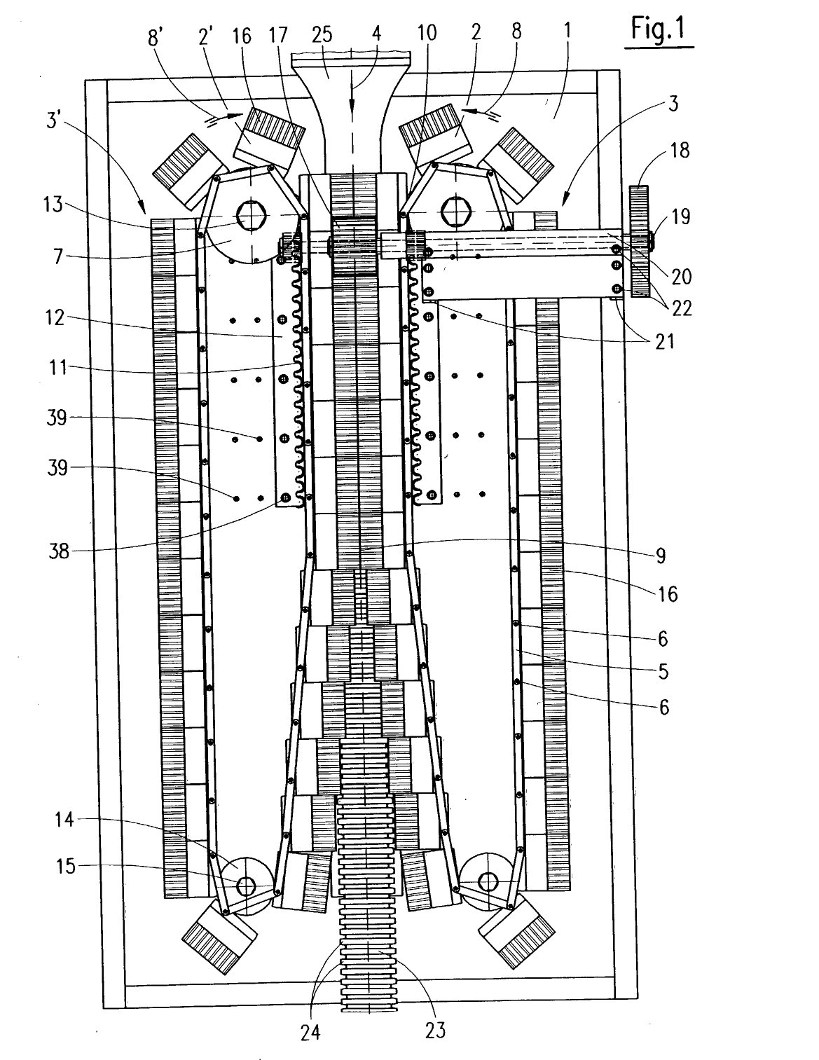

As seen in FIG. 1, an apparatus for the manufacture of plastic twin-wall pipes with cross grooves comprises a machine bed 1, on which half shells 2 and 2′ are disposed, which are joined to each other, forming two so-called chains 3 and 3′. To this end, a bracket 5 is articulated by means of a pin 6 to each half shell 2 and 2′ in the outward front portion thereof which leads in the direction of production 4; this bracket 5 is mounted on the succeeding half shell 2 in the corresponding place likewise by means of such a pin 6. By their rear end seen in the direction of production 4, the chains 3, 3′ thus formed are guided along feed rollers 7 which serve as deflection wheels. Upon circulation of the chains 3, 3′ in the direction of the arrows 8, 8′, the individual half shells 2, 2′ are moved into a molding path 9 where two half shells 2, 2′ are united to form a pair; pairs of shells which are successive in the direction of production 4 lie close together. For rapid closing of the half shells 2, 2′ into a parallel and adjoining position, so-called closing rollers 10 are provided, which accelerate the joining of the rear ends—in the direction of production 4—of the half shells 2, 2′.

On the molding path 9 itself, the adjoining half shells 2, 2′ are pressed against each other by means of guide rollers 11, which are rotatably mounted in guide rails 12 that can be adjusted horizontally and crosswise of the direction of production 4. The feed rollers 7 are mounted on the machine bed 1 for rotation about axle ends 13. At the front end, seen in the direction of production 4, of the machine bed 1, return rollers 14, which also serve as deflection wheels, are mounted for rotation about axle ends 15; the chains 3 and 3′ are deflected by these return rollers 14 and guided back to the feed rollers 7. As seen in FIG. 1, the guide rails 12 with the guide rollers 11 terminate by the length of several half shells 2 and 2′ before the return rollers 14 so that the half shells 2 and 2′ can be moved apart parallel to each other and crosswise of the direction of production 4 prior to being deflected by the return rollers 14.

An indentation 16 is formed on the upper side of the half shells 2, 2′, the two indentations 16 of the half shells 2, 2′ which are allocated to each other in pairs being in alignment so that a joint driving pinion 17 can engage with this indentation 16 from above, pushing the half shells 2, 2′ in the molding path 9 as a closed mold through the molding path 9. Actuation of this driving pinion 17 takes place in the usual way by a motor (not shown) via a driving gear 18 which is non-rotatably fixed on a shaft 19, the shaft 19 again carrying the driving pinion 17. The shaft 19 is run in a bearing 20 which is supported on the machine bed for height adjustment by way of spacers 21 and joined thereto by means of fasteners 22.

The apparatus illustrated serves for the manufacture of plastic pipes 23, namely so-called corrugated, twin-wall or gilled pipes, that have a cross-groove profile i.e., with grooves 24 encircling over the periphery thereof. The pipes 23 may also be flexible and single-wall i.e. corrugated tubes. An extruder is provided for the manufacture of the pipes 23, the pipe die 25 of which is roughly outlined; the pipe die 25 is the extrusion head of the extruder. Extruded from the pipe die 25 is a tube (not shown) which, while still in a thermoplastic condition, arrives in the mold on the molding path 9 where the cross-groove profile is formed. The apparatus described hereinbefore has been known for example from U.S. Pat. No. 6,045,347. So-called twin-wall pipes can be produced in the same way by this apparatus, which are externally similar to the pipe 23 and which are internally provided with an integral continuous smooth pipe.

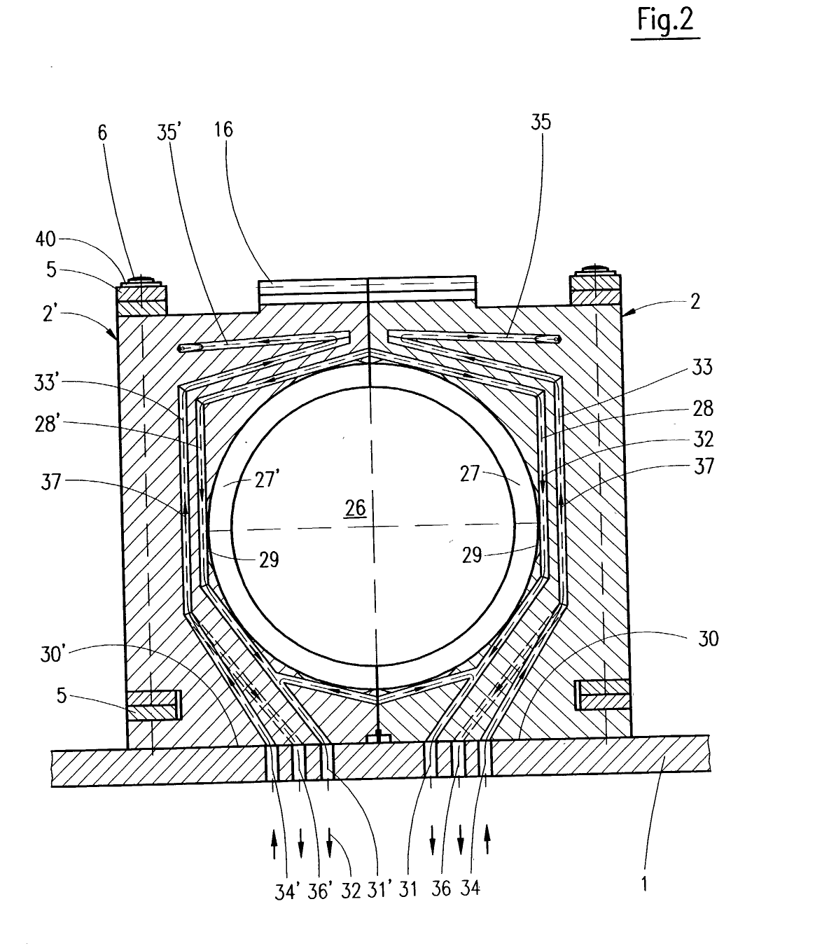

The half shells 2, 2′, which are allocated to each other in pairs, are cooled on the molding path 9; moreover, molding the grooves 24 takes place by vacuum actuation of the mold cavity 26 formed on the molding path 9. The mold recesses 27, 27′ provided in the half shells 2, 2′ for formation of the mold cavity 26 have a shape complementary of the outer shape of the pipe 23. The half shells 2, 2′ are provided with vacuum ducts 28, 28′ that run in proximity to the wall of the mold recess 27 and 27′, enclosing it at a comparatively small distance when the half shells 2, 2′ adjoin by twos. Numerous vacuum slits 29 discharge from the vacuum ducts 28, 28′ into the mold cavity 27, 27′. As seen in FIG. 2, the vacuum ducts 28, 28′ are connected to each other when the half shells 2, 2′ adjoin. The vacuum ducts 28, 28′ open into the lower side 30, 30′, resting of the machine bed 1, of the half shells 2, 2′. When the half shells 2, 2′ adjoin in pairs, they overlap vacuum connections 31, 31′ which are provided on the machine bed 1 and connected to a vacuum pump (not shown). The air flow in the vacuum ducts 28, 28′ and vacuum connections 31, 31′ is marked by the arrows 32.

Cooling channels 33, 33′ are provided in the half shells 2, 2′; they are not connected with each other in the half shells 2, 2′ that are allocated to each other in pairs. They start on the respective lower side 30, 30′ of the corresponding half shell 2, 2′ where they overlap cooling water flow lines 34, 34′ in the machine bed 1 when the half shells 2, 2′ adjoin. From there, the cooling channels 33, 33′ pass at a distance around the respective mold recess 27, 27′. Provided below the indentation 16 are additional cooling channels 35 and 35′ that are guided outwards. Seen in the direction of production 4, the cooling channels 33, 33′ are disposed at a comparatively small distance from each other. Two cooling channels 33 and 33′ neighboring in the direction of production 4 are connected with each other. With one cooling channel 33 and 33′, respectively, being connected to the cooling water flow line 34 and 34′, respectively, the ensuing cooling channel 33, 33′ in the direction of production 4 may in this way be connected to a cooling water return line 36, 36′ in the machine bed 1, as seen in particular in FIG. 2 left half. The cooling water flow direction is roughly outlined by the arrows 37. The vacuum and cooling water guidance are known for instance from U.S. Pat. No. 4,492,551.

The guide rails 12 are horizontally adjustable crosswise of the direction of production 4 so that the molding path 9 may be set for half shells 2, 2′ of varying widths. The guide rails 12 can be fixed on the machine bed 1 by means of screws 38, to which end several rows of threaded holes 39 are provided in the machine bed 1 transversely to the direction of production 4. Each row of threaded holes 39 corresponds to a certain width of a half shell 2, 2′.

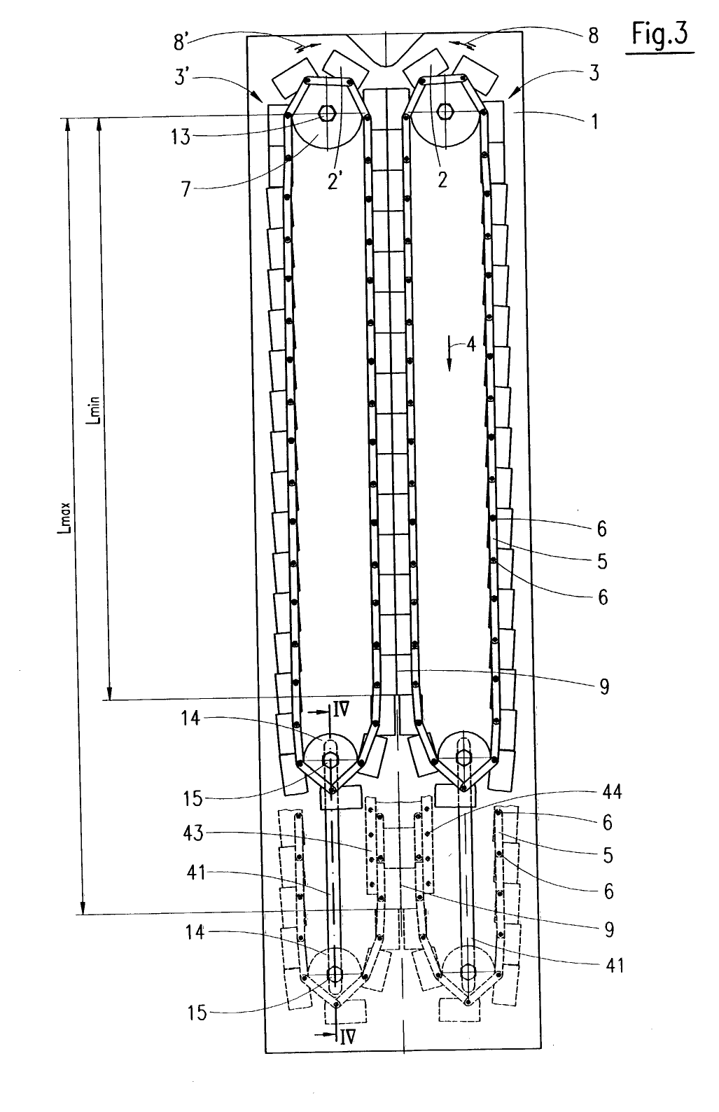

The machine according to the invention seen in FIG. 3 differs from the familiar machine seen in FIGS. 1 and 2 by the—referred to the direction of production 4—downstream area seen in FIG. 3 bottom. Although the individual parts in FIG. 3 do not look identically the same as in FIG. 1—due to the diagrammatic illustration—the same reference numerals as used as in FIG. 1, there being no need of renewed description.

As seen in FIG. 2, the half shells 2, 2′ may easily be replaced when the securing rings 40 on the pins 6 are loosened.

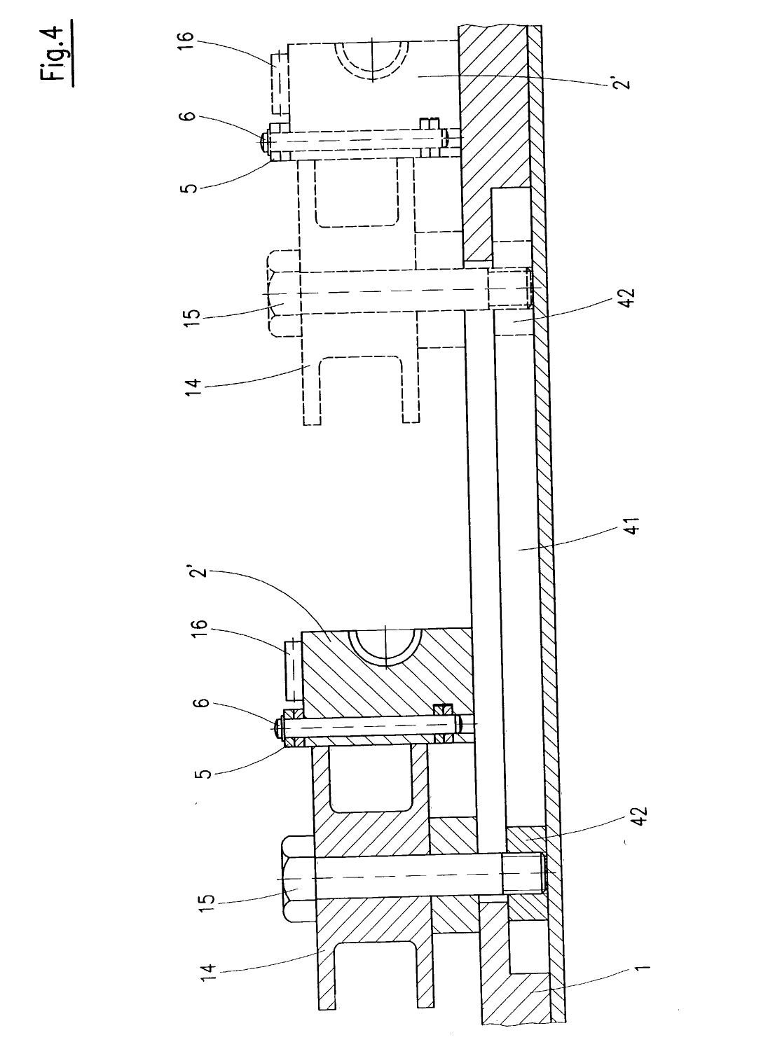

As seen in FIG. 3 bottom, the return rollers 14 are lodged in the machine bed for adjustment in the direction of production. As compared to the embodiment of FIG. 1, the machine bed 1 is extended in the direction of production. The axle ends 15 of the return rollers 14 are disposed in slits 41 of the machine bed 1 that run in the direction of production and can be moved therein in the direction of production. As seen in FIG. 4, the axle ends 15 are releasably joined to the machine bed 1 by means of fastening means 42. They can be loosened from above and, after displacement of the axle end 15 along with the return roller 14, they may again be tightly connected with the machine bed 1. As a result, the length of the molding path 9 may vary between a minimum length Lₘᵢₙ and a maximum length Lₘₐₓ. An embodiment with as short a molding path 9 as possible is shown in solid lines in FIG. 3, whereas the embodiment with the longest possible molding path 9 is outlined by dashed lines. The mentioned measures illustrated in FIG. 2 for vacuum actuation and cooling of the half shells 2, 2′ only reach over the shortest possible length Lₘᵢₙ of the molding path 9. The portion that reaches beyond as far as Lₘₐₓ does not comprise any corresponding devices in the machine bed 1. Downstream of the guide rails 12 (not shown in FIG. 3), rails 43 (roughly outlined in FIG. 3) are provided in the area between Lₘᵢₙ and Lₘₐₓ, which are fastened by screws 44 on the machine bed 1 and are suited to the factual length of the molding path. They only serve to prevent the half shells 2, 2′ from being moved without control and totally without guidance prior to being led apart regularly. As a result of the adjustability in length, the length of the mold chains 3, 3′ can be changed, enabling pipes of varying, however given length to be manufactured by only some minor modifications of the apparatus without the production of waste.

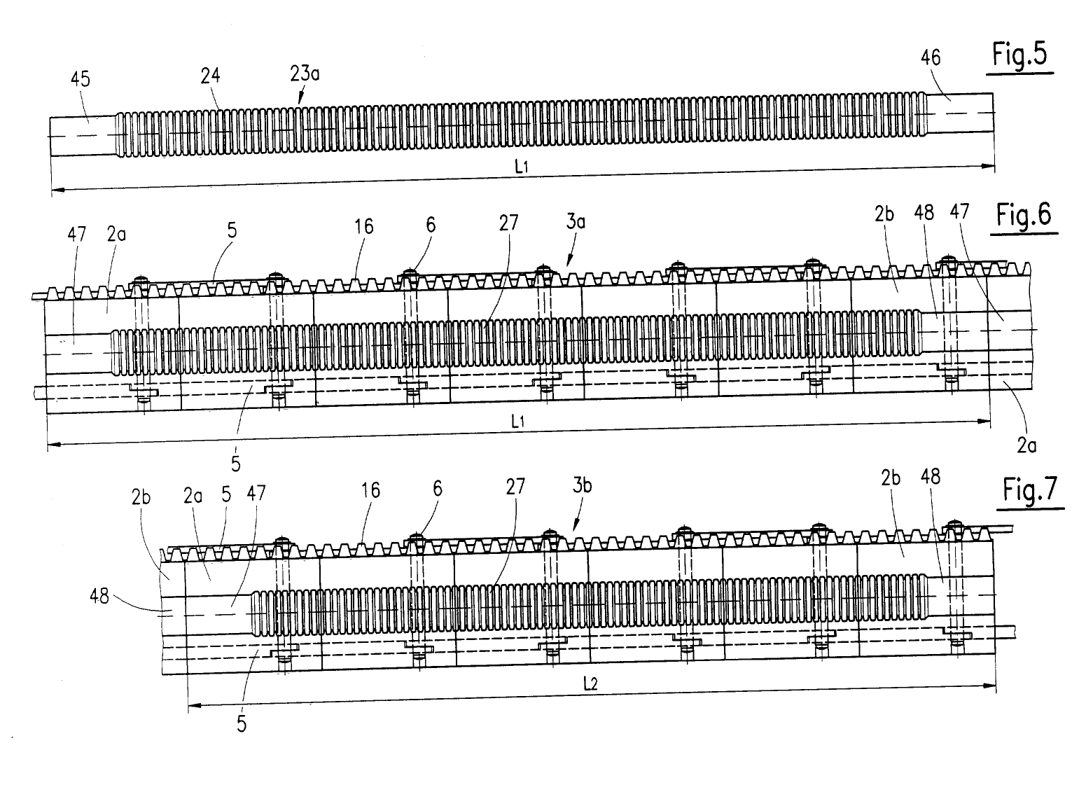

FIG. 5 illustrates a flexible corrugated pipe 23a i.e., a corrugated tube, which has a smooth connecting piece 45, 46 at each end. To this effect, half shells 2a, 2b are equipped with smooth mold recess sections 47, 48 as seen in FIG. 6. Depending on the length of the pipe 23a that is to be produced, a sufficiently great number of pairs of half shells 2, 2a, 2b is disposed within each chain so that upon complete circulation of a chain 3, an integral number of these pipes 23a of a length L₁ is successively produced.

The pipe 23a that can be made in keeping with the embodiment of FIG. 7 has a length L₂ which differs from L₁ by the length 1 of a half shell 2. Consequently L₁−L₂=1 applies. Of course, the difference may be a whole multiple of 1. For corresponding changes in length, a single or several half shells 2 are removed from, or inserted into, each chain.

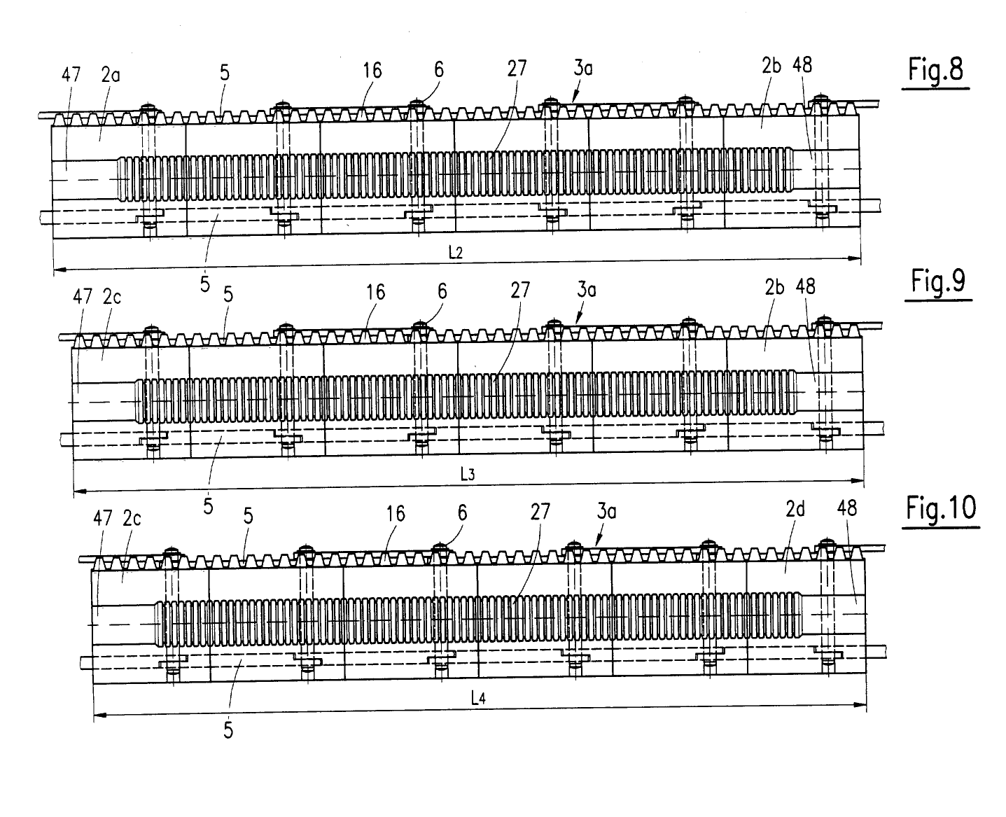

More finely graded possibilities of length modification will become apparent from FIGS. 8 to 10. In this case, the half shell 2a seen in FIG. 8, in which the connecting piece 45 is molded among others, is replaced by a shorter half shell 2c (FIG. 9), whereby fine graduation in the length of the to be produced pipe 23a is attainable. In the embodiment according to FIG. 10, both half shells 2a, 2b are replaced by half shells 2c, 2d of reduced length. The described measures serve to obtain varying lengths L₂ (FIG. 8), L₃ (FIG. 9) and L₄ (FIG. 10) of the pipes.

What is claimed is:

1. An apparatus for the manufacture of corrugated plastic pipes (23, 23a), comprising
a machine bed (1);
a molding path (9), which extends on the machine bed (1) in a direction of production (4);
two feed and deflection devices (7) upstream of the molding path (9) in the direction of production (4);
two return and deflection devices (14) downstream of the molding path (9) in the direction of production (4);
half shells (2, 2′; 2a, 2b; 2c, 2d),
which are releasably connected to one another, continuously forming two mold chains (3, 3′; 3a),
which combine by twos on the molding path (9), forming a mold, and
which are passed along a feed and deflection device (7) and a return and deflection device (14); and
a drive for advancing the half shells (2, 2′; 2a, 2b; 2c, 2d) through the molding path (9);
wherein the return and deflection devices (14) are mounted on the machine bed (1) for adjustment in the direction of production (4).

2. An apparatus according to claim 1,
wherein the return and deflection devices (14) are mounted on the machine bed (1) for infinitely variable adjustment.

3. An apparatus according to claim 1,
wherein the return and deflection devices (14) are disposed for displacement in slits (39) in the machine bed (1) that extend in the direction of production (4).

4. An apparatus according to claim 1,
wherein the molding path (9) has a constant length.

5. An apparatus according to claim 1,
wherein the return and deflection devices are return rollers (14). 6. An apparatus according to claim 1,
wherein half shells (2a, 2b; 2c, 2d) of varying length are exchangeably employable.
